(19) United States
(12) Patent Application Publication
(10) Pub. No.: US 2020/0154700 A1
(43) Pub. Date: May 21, 2020

(54) Antibacterial and Non-Clumping Liquid Spray

(71) Applicants: Aldo Laghi, Pinellas Park, FL (US); Alps South Europe S.R.O., Plzen (CZ)

(72) Inventor: Aldo Laghi, Pinellas Park, FL (US)

(21) Appl. No.: 16/745,712

(22) Filed: Jan. 17, 2020

Related U.S. Application Data
(63) Continuation-in-part of application No. 15/990,859, filed on May 29, 2018.
(60) Provisional application No. 62/644,614, filed on Mar. 19, 2018.

(51) Int. Cl. A01N 25/06; A01N 33/12

(52) U.S. Cl. CPC A01N 25/06; A01N 33/12

(57) ABSTRACT

A liquid spray system having antimicrobial and non-clumping properties that may be achieved without having more than 100% of the electron cation exchange. The agent may be chosen from a large number of antimicrobial agents, wherein a QAC or similar compound is the most desirable. When the spray is applied to a surface, the surface does not exhibit a formation of clumps or coagulations, etc. This non-clumping property may be achieved three different ways. First, the agent may be dissolved in a specially denatured alcohol or similar solvent carrier. Second, the agent may be dissolved in water or an SDA and then forced into a fine mist by way of a high pressure gas. Third, the agent may be dissolved into a water in oil emulsion. Further, the spray allows for no amount of carrier solvent to make contact with the surface of the material being treated.

### CROSS-REFERENCE TO RELATED APPLICATIONS

This application is a continuation-in-part of application Ser. No. 15/990,859 titled “Antibacterial and Non-Clumping Liquid Spray,” filed May 29, 2018 which claims the benefit of provisional application 62/644,614, filed Mar. 19, 2018, the disclosure of which is incorporated by reference herein.

### BACKGROUND OF THE INVENTION

### Field of the Invention

This invention relates to a liquid chemical composition that has antibacterial and non-clumping properties when applied to a material. Specifically, the invention relates to a liquid chemical composition comprising quaternary amine compounds delivered by spraying to decontaminate a material while preventing clumping of the material.

### Description of the Background Art

Presently, house animals, such as cats, use litter boxes as a bathroom. The litter boxes are generally large enough for the cat to choose different areas as a target. Then the cat may or may not involuntarily step on feces or urine when choosing another target. If the cat then uses his dirty claw to scratch a person, that person may then develop the disease called toxoplasmosis caused by the parasite, Toxoplasma gondii, which is frequently present in the feces of a cat. This disease can result in a lowered immunity and may be transferred from an infected mother to a child during pregnancy. The child may then develop flu-like symptoms upon birth. It is also recommended that pregnant mothers refrain from cleaning used litter boxes as pregnant mothers may come into contact with the parasite, even without being directly scratched by a cat's claw.

Cat litter is a collection of loose particles and is generally comprised of sodium bentonite, among other materials. Sodium bentonite is the name of the ore whose major constituent is the mineral sodium montmorillonite. Montmorillonites are three-layer materials consisting of two tetrahedral layers sandwiched around a central octahedral layer. Sodium bentonite has a slight negative charge to its surface and attracts water to its central octahedral layer. This attraction causes large amounts of bentonite to clump together in the presence of water and is the reason bentonite is attractive as a cat litter.

Presently, antibacterial sprays can be used to sanitize surfaces, such as cat litter. While many of these sprays are successful with regards to one purpose, they are deficient with regards to a different purpose. That is, while some sprays may eliminate bacteria, they actually clump together the material composing the surface. The method to clean cat litter involves using a scooping device that selectively gathers larger objects while leaving smaller objects behind. That is, the feces are removed while the litter remains in the box. If clumps were present during cleaning, the feces and litter clumps would be removed together, thus resulting in the disposal of relatively clean cat litter.

Further, current alcohol-based sprays can leave alcoholic residue on the surface of the material being sprayed. When the material is cat litter, having alcoholic residue on the material limits the usefulness as most cats do not like the odor of alcohol and will refuse to use the cat litter, resulting in accidents around the home. Thus, it is an important aspect of this invention that the solvent carrier be propelled as a fine mist and for it to evaporate before hitting the surface of the material so that it does not sit on the material. This evaporative effect is achieved through the use of a high vapor pressure, low flash point carrier.

Therefore, it is an object of this invention to provide an improvement which overcomes the aforementioned inadequacies of the prior art and provides an improvement which is a significant contribution to the advancement of the antibacterial spray art.

A further object of the present invention is to provide an anti-bacterial spray for materials made of loose particles that does not cause the material to clump when the spray is applied.

Another object of the present invention is to prevent the accumulation of Toxoplasma gondii on materials.

Another object of the present invention is to prevent the transmission of toxoplasmosis and other diseases.

Another object of the present invention is to utilize the chemical properties of materials such as bentonite to prevent clumping.

Another object of the present invention is to provide a composition capable of spraying such that any solvent carrier being used evaporates before transmission to the subject material.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a liquid spray that is used for the purpose of eliminating bacteria from a material as well as preventing the material from clumping.

Embodiments of the present invention are herein described by way of example and directed to a spray having antimicrobial and non-clumping properties. The aforementioned state of the art of antibacterial sprays shows the need for improvements, specifically in the ability of the spray to eliminate bacteria while having non-clumping properties when applied to the material.

The spray is composed of particles having antibacterial properties. The non-clumping properties of the spray may be achieved by techniques involving the use of a specially denatured alcohol (“SDA”) having a high vapor pressure and low flash point as a component of the composition, or using a fine water mist employing pressurized nitrogen gas, or using a water in oil emulsion. The antibacterial and non-clumping properties of the present invention satisfies the aforementioned deficiencies because of its unique design and ability to properly eliminate bacteria as well as providing non-clumping properties to the material.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION OF THE PREFERRED EMBODIMENT

In one embodiment, the spray of this disclosure is an antibacterial liquid spray that when sprayed onto a material, provides non-clumping properties to that material. As used herein, the term “antibacterial” encompasses all natural progressions and derivations of the act of killing or eliminating bacteria. As used herein, the term “antimicrobial” encompasses all natural progressions and derivations of the act of killing or eliminating bacteria, algae, fungi, viruses, yeast and molds. As used herein, the term “non-clumping” encompasses all natural progressions and derivations of the proposition that, once the material comprising loose particles is sprayed, the material will then not undergo the formation of clumps, clusters, mounds, formations, coagulations, growths, etc.

The spray described in this disclosure is composed of an antibacterial agent dissolved or dispersed in a liquid. Any inorganic material exhibiting a combination of high surface area and a relatively significant ion exchange capacity (or “electron cation exchange”), is useful as particles in the present disclosure. Typical particles include natural and synthetic clay materials as well as zeolites, illite, chlorite, kaolinite, hydrotalcite, talc, halloysite, sepiolite and palygorskite. Electron cation exchange is of particular importance to the current invention because it defines the ability of the particles, such as clay minerals, to exchange their cations thereby imparting antimicrobial properties to the clay minerals.

Desirable antimicrobial agents having antimicrobial properties may include quaternary ammonium compounds (“QAC”), transition metals, organo metallic compounds, perchlorates, charged halogen-containing compounds, charged organic peroxides, ionic polymers, ionic surfactants, and derivatives and mixtures thereof. QACs of particular desirability include benzalkonium and benzethonium. This list is non-limiting and other similar QACs may be used. Other, non-QAC, antimicrobial agents can be used in water-in-oil emulsions if the agent is water soluble or in a lipid solution if the agent is oil soluble.

The QAC component of the composition can be used as a bactericidal and bacteriostatic on organisms such as Streptococcus pyogenes C-203, Streptococcus viridans, Escherichia coli (E. Coli), Salmonella gallinarum, Salmonella choleraesuis, Salmonella typhimurium, Salmonella schottmulleri, Pseudomonas aeruginosa PRD-10, Lactobacillus casei, Shigella sonnei, Klebsiella pheumoniae, Saccaromyces cerevisiae, Pityrosporum ovale, Trichophyton mentagrophytes, Monilia albicans, Aspergillus niger, Apergilus oryzae, Penicillium notatm, and Penicillium luteum among others.

Notably, the antimicrobial agents are retained even after substantial force is applied such as in washing or cleaning. Thus, this composition is stable and long lasting. As stated above, this invention does not require a substantially high electron cation exchange percentage. In one embodiment, the invention requires less than 100% of the electron cation exchange of the particles.

A preferred composition is a water-oil emulsion that comprises 0.2% antimicrobial agent, 30% water, 30% mineral oil, and 40% petrolatum by weight. The percentages of mineral oil and petrolatum can be varied to create a the spray having the desired consistency. An additional preferred composition contains 0.05% to 10% antimicrobial agent and 99.9% to 99% by weight ethanol, SDA, glycol, or other alcohol or glycol or other solvent of the antimicrobial agent having a high vapor pressure and low flash point. The alcohol or glycol can be diluted with as much as 30% water and still provide the anti-clumping properties that are desired. Yet another composition only uses 0.05% to 1% antimicrobial agent mixed in water. It is an important limitation of this invention that the solvent evaporates before hitting the material that is being sprayed.

A significant aspect of this invention is the ability of the antimicrobial spray to be sprayed onto a material, whereupon the material does not form significant clumps. That is, the spray imparts non-clumping properties to the material. In one instance, the non-clumping property was achieved by using a non-water solvent carrier such as an alcohol or glycol as a component of the spray composition. The solvent carrier, given that it contains little or no water, provides the non-clumping feature to the antimicrobial spray, while at the same time delivering the QAC to the litter.

In a second instance, the non-clumping property was achieved by using a high pressure propellant, such as nitrogen, butane, propane, or other similar propellant, to form the composition into a fine mist. The small particle size of the mist prevent the water molecules from forming clumps in the material. The same concentration of QAC or other antimicrobial agent should be used in this embodiment as in the embodiment using an alcohol or glycol. The antimicrobial agent in this embodiment is simply mixed with water and the creation of the fine mist prevents any clumping from occurring.

In a third instance, the non-clumping property was achieved by using a water in oil emulsion. The purpose of using a water in oil emulsion is due to the fact that many surfaces are composed of oil based products. That is, they are hydrophilic and clump together when in the presence of water. Having a water in oil emulsion allows the agent to be positioned within the bentonite such that it displaces the normally ensnared water molecules. To prepare the water in oil emulsion, the agents are dissolved in water, ethanol, or another solvent, separately or in combination, in the water phase of the water in oil emulsion preparation.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A method of disinfecting a bentonite-containing material comprising:
preparing a liquid antimicrobial spray composition comprising:
0.05% to 10% by weight of an antimicrobial agent;
less than 20% by weight water;
a propellant; and
a high vapor pressure and low flash point solvent; and
spraying said liquid antimicrobial spray composition on the bentonite-containing material wherein no amount of solvent makes contact with the bentonite-containing material.

2. The method of disinfecting a bentonite-containing material of claim 1 wherein the solvent is ethanol.

3. The method of disinfecting a bentonite-containing material of claim 1 wherein the solvent is specially denatured alcohol.

4. The method of disinfecting a bentonite-containing material of claim 1 wherein the solvent is glycol.

5. The method of disinfecting a bentonite-containing material of claim 1 wherein the composition has less than 100% electron cation exchange.

6. The method of disinfecting a bentonite-containing material of claim 1 wherein the composition comprises 1% by weight antimicrobial agent.

7. The method of disinfecting a bentonite-containing material of claim 1 wherein the antimicrobial agent is a compound selected from at least one member of the group consisting of a quaternary ammonium compound, a transition metal, an organo metallic compound, a perchlorate, a charged halogen-containing compound, a charged organic peroxide, an ionic polymer, and an ionic surfactant.

8. The method of disinfecting a bentonite-containing material of claim 1 wherein the liquid antimicrobial spray composition comprises 10% by weight water.

9. The method of disinfecting a bentonite-containing material of claim 1 wherein the liquid antimicrobial spray composition is sprayed as a fine mist by using a pressurized propellant.
